(19) United States
(12) Patent Application Publication
(10) Pub. No.: US 2006/0119741 A1
(43) Pub. Date: Jun. 8, 2006

(54) Tuning apparatus

(76) Inventors: Daniel Mark Hutchinson, Carmel, IN (US); Clint Alan Ecoff, Indianapolis, IN (US); Gene Harlow Johnson, Carmel, IN (US)

Correspondence Address: THOMSON LICENSING INC., PATENT OPERATIONS, PO BOX 5312, PRINCETON, NJ, 08543-5312, US

(21) Appl. No.: 10/512,330

(22) PCT Filed: Apr. 11, 2003
(86) PCT No.: PCT/US03/10984

§ 371 Date: Oct. 22, 2004

Related U.S. Application Data
(63) Continuation-in-part of application No. 60/374,953, filed on Apr. 23, 2002.

(51) Int. Cl. H04N 5/44

(52) U.S. Cl. 348/725

(57) ABSTRACT

A tuning apparatus compensates for temperature-related frequency variations of a filter. According to an exemplary embodiment, the tuning apparatus includes an RF signal source, a tuner, and the filter. The tuner includes a local oscillator and is coupled between the RF signal source and the filter and provides an IF signal for the filter. The tuner also includes a frequency adjustment mechanism for adjusting the frequency of the local oscillator in response to a temperature characteristic of the filter.

The present invention generally relates to tuner control, and among other things includes a technique for controlling a tuning apparatus to compensate for temperate-related frequency variations of a filter.

The process for tuning one frequency channel out of a plurality of frequency channels may include mixing a radio frequency (RF) signal containing multiple frequency channels with the center frequency of a frequency channel of interest, and using a filtering operation to pass the frequency channel of interest and reject all other frequency channels. Such a process is commonly used by devices, such as television signal receivers, cable modems and/or other devices.

The filtering operation used to pass the frequency channel of interest in the above-referenced tuning process often utilizes one or more surface acoustic wave (SAW) filters. In particular, lithium tantalate (LiTa) SAW filters are often used to perform such a filtering operation in devices such as television signal receivers due to their relatively low temperature coefficient. However, LiTa SAW filters have certain disadvantages. For example, the application circuit design for LiTa SAW filters tends to be difficult. Moreover, LiTa SAW filters typically require impedance matching components which may not be necessary with other types of filters. Accordingly, there are certain advantages associated with avoiding the use of LiTa SAW filters.

One alternative to a LiTa SAW filter is a lithium niobate (LiNb) SAW filter. However, while LiNb SAW filters may avoid some of the problems associated with LiTa SAW filters, they too may be problematic. In particular, a LiNb SAW filter tends to be temperature dependent in its operation. These temperature dependent characteristics of LiNb SAW filters can be especially problematic in certain applications. For example, when a LiNb SAW filter is used in a device such as a television signal receiver, its temperature dependent characteristics can cause its center output frequency to vary depending on the ambient temperature. This frequency variation can in turn create problems with the picture-to-noise ratio of the receiver.

Accordingly, there is a need for a tuning apparatus and method which avoids the foregoing problems, and thereby enables the use of LiNb SAW filters in devices such as television signal receivers, while avoiding problems associated with its temperature dependent characteristics. The present application addresses these and other issues.

In accordance with an aspect of the present invention, a tuning apparatus is disclosed. According to an exemplary embodiment, the tuning apparatus comprises an RF signal source, filter means, and tuning means. The tuning means includes a local oscillator and is coupled between the RF signal source and the filter means for providing an IF signal for the filter means. The tuning means also includes adjustment means for adjusting the frequency of the local oscillator in response to a temperature characteristic of the filter means.

In accordance with another aspect of the present invention, a method for controlling a tuning apparatus is disclosed. According to an exemplary embodiment, the method comprises steps of receiving an RF signal, generating an IF signal from the RF signal and providing the IF signal to a filter of the tuning apparatus, and controlling a frequency of the IF signal based on a temperature characteristic of the filter.

The above-mentioned and other features and advantages of this invention, and the manner of attaining them, will become more apparent and the invention will be better understood by reference to the following description of embodiments of the invention taken in conjunction with the accompanying drawings, wherein:

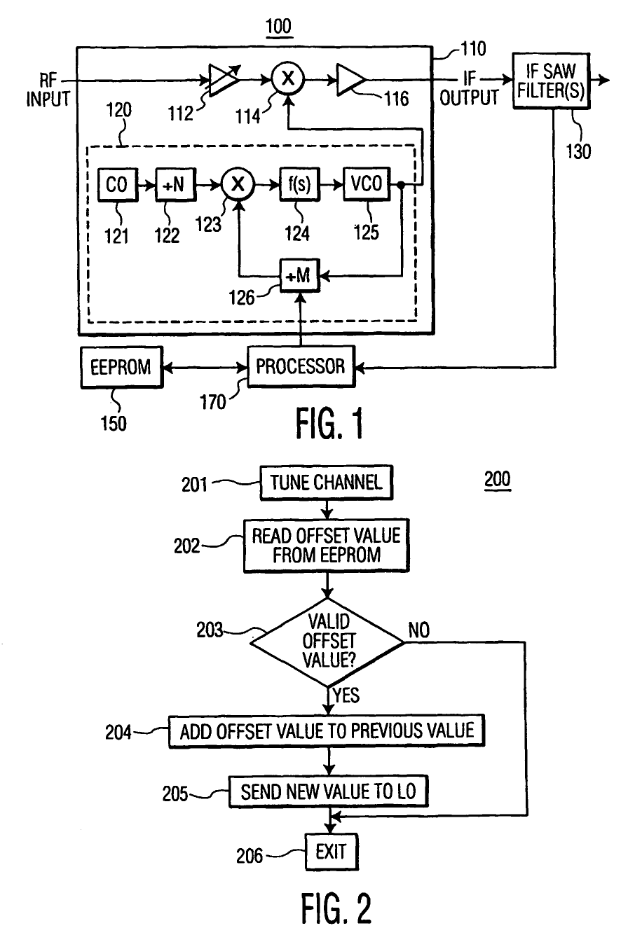

FIG. 1 shows an exemplary tuning apparatus suitable for implementing the present invention; and

FIG. 2 is a flowchart illustrating exemplary steps according to the present invention.

The exemplifications set out herein illustrate preferred embodiments of the invention, and such exemplifications are not to be construed as limiting the scope of the invention in any manner.

Referring now to the drawings, and more particularly to FIG. 1, an exemplary tuning apparatus 100 suitable for implementing the present invention is shown. Tuning apparatus 100 shown in FIG. 1 may for example represent a portion of a television signal receiver. However, it will be intuitive to those skilled in the art that the principles of the present invention may be applied to any apparatus that uses a tuner to select a desired channel, such as in a frequency division multiplexing (FDM) system.

In FIG. 1, tuning apparatus 100 comprises tuning means such as tuner 110, and filter means such as intermediate frequency (IF) SAW filter 130. Control means including memory means such as electrically-erasable, programmable read-only memory (EEPROM) 150 and processing means such as processor 170 are also included in FIG. 1.

Tuner 110 comprises a variable-gain amplifier 112, a multiplier 114, an amplifier 116, and a local oscillator (LO) 120. LO 120 comprises a crystal oscillator (CO) 121, a fixed divide-by-N frequency divider 122, a multiplier 123, a loop filter f(s) 124, a voltage-controlled oscillator (VCO) 125, and frequency adjustment means such as programmable divide-by-M frequency divider 126. The foregoing elements may for example be embodied using one or more integrated circuits (ICs).

Tuner 110 is operative to receive an RF input signal (i.e., RF INPUT) and perform a tuning operation thereon to thereby generate and output a tuned intermediate frequency (IF) signal (i.e., IF OUTPUT). As will be explained later herein, the tuned IF signal provided by tuner 110 may be frequency adjusted to compensate for temperature-related frequency variations (i.e., drifts) in the outputs of IF SAW filter 130. For purposes of example, tuner 110 is shown in FIG. 1 as a single frequency conversion tuner. However, it will be intuitive to those skilled in the art that the principles of the present invention may be applied to any tuner architecture.

In FIG. 1, variable-gain amplifier 112 receives and amplifies the RF input signal to thereby generate and output an amplified RF signal. The RF input signal may be provided to tuner 110 via any wired or wireless signal source such as, but not limited to, a satellite, cable, or terrestrial broadcast. Multiplier 114 receives the amplified RF signal from amplifier 112, and multiplies the same by an output frequency signal from LO 120 to thereby generate and output an IF output signal. The output frequency of LO 120 is fₒ=fᵣ×M/N, where fᵣ is the reference frequency generated by CO 121. Since M and N must be integer values greater than zero, the frequency step size of LO 120 (i.e., the minimum change in fₒ) is Δfₒ=fᵣ/N. Amplifier 116 receives the IF output signal from multiplier 114, and amplifies the same to thereby output the tuned IF signal to IF SAW filter 130.

IF SAW filter 130 comprises one or more filters and is operative to filter the tuned IF signal output from tuner 110. According to an exemplary embodiment, the one or more filters of block 130 are LiNb SAW filters, which are temperature dependent in operation. In particular, the temperature dependent characteristics of LiNb SAW filters can cause the center output frequency of IF SAW filter 130 to vary depending on the ambient temperature. In cases where the tuned IF signal output from tuner 110 is a vestigial-sideband signal with video modulation, and IF SAW filter 130 has a Nyquist slope intended to coincide with the double-sideband region of the signal spectrum, this frequency variation of IF SAW filter 130 will create problems with the frequency response and picture-to-noise ratio at the output of a subsequent demodulator.

IF SAW filter 130 may also include a temperature sensing device which measures the current ambient temperature, and outputs a control signal representative of this temperature to processor 170. As will be explained later herein, this control signal enables the tuned IF signal to be generated by tuner 110 in an adaptive manner based on the most current temperature conditions associated with IF SAW filter 130.

EEPROM 150 is a non-volatile memory operative to store digital data comprising one or more offset values associated with the temperature characteristics of IF SAW filter 130. According to an exemplary embodiment, EEPROM 150 stores at least one offset value corresponding to ambient temperature range(s) associated with IF SAW block 130. With this exemplary embodiment, the offset value used to control tuner 110 may be a fixed, predetermined value which is established based on design considerations of tuning apparatus 100, and is fixed in tuning apparatus 100 at the time of manufacture.

According to another exemplary embodiment, EEPROM 150 stores a plurality of offset values and each such value corresponds to a different ambient temperature range associated with IF SAW filter 130. With this exemplary embodiment, IF SAW filter 130 may include a temperature sensing device which measures the current ambient temperature associated with IF SAW filter 130 on a real-time basis, and outputs a corresponding temperature control signal representative of this temperature to processor 170 which controls tuner 110 accordingly.

Processor 170 is operative to perform various processing operations. According to an exemplary embodiment, processor 170 reads an offset value from EEPROM 150 and generates a control signal based on the offset value to control LO 120 of tuner 110. As previously indicated, processor 170 may read an offset value from EEPROM 150 based on a control signal from IF SAW filter 130 which indicates the current ambient temperature associated with IF SAW filter 130.

To facilitate a better understanding of the inventive concepts of the present invention, a more concrete example will now be provided. Referring to FIG. 2, a flowchart 200 illustrating exemplary steps according to the present invention is shown. For purposes of example and explanation, the steps of FIG. 2 will be described with reference to tuning apparatus 100 of FIG. 1. The steps of FIG. 2 are merely exemplary, and are not intended to limit the present invention in any manner.

At step 201, a channel tuning operation is performed. According to an exemplary embodiment, the channel tuning operation may be performed in a conventional manner in response to a channel change operation initiated by a user, or in response to a device including tuning apparatus 100 (e.g., television signal receiver) being turned on. To enable the channel tuning operation at step 201, processor 170 sends an M value to programmable divide-by-M frequency divider 126 of LO 120. This M value causes LO 120 to generate an output frequency fₒ which should put the IF frequency output from IF SAW filter 130 close to its nominal frequency. According to an exemplary embodiment, this nominal frequency is 45.75 MHz and represents a picture carrier. Processor 170 also saves the M value sent to programmable divide-by-M frequency divider 126.

At step 202, an offset value is read from EEPROM 150 by processor 170. According to one exemplary embodiment, the offset value is a fixed, predetermined value which is established based on design considerations of tuning apparatus 100, and is fixed in tuning apparatus 100 at the time of manufacture. For example, according to an exemplary design, IF SAW filter 130 is a LiNb SAW filter designed to operate at an ambient temperature of 40° C. With this exemplary design, the offset value may be zero if the ambient temperature associated with IF SAW filter 130 is also 40° C.

According to another exemplary embodiment, the offset value is variable, and is read from EEPROM 150 by processor 170 adaptively based on the current ambient temperature associated with IF SAW filter 130. As previously indicated herein, IF SAW filter 130 may include an associated temperature sensing device with this embodiment which measures the current ambient temperature and outputs a control signal representative of this temperature to processor 170. Processor 170 then reads an offset value from EEPROM 150 which corresponds to the current ambient temperature. In this manner, the offset value read by processor 170 is based on the most current temperature conditions associated with IF SAW filter 130.

The use of variable offset values may for example be appropriate when the ambient temperature associated with IF SAW filter 130 is subject to significant variations. For example, there may be certain applications where the ambient temperature associated with IF SAW filter 130 can vary from 25° C. to 75° C. depending on factors such as, the final mechanical packaging and/or whether a cooling fan is employed. Since LiNb SAW filters have a −72 ppm/° C. temperature coefficient, this 50° C. uncertainty in temperature is equivalent to a 164.7 kHz (i.e., 72×45.75×50) uncertainty in the ideal IF frequency output from IF SAW filter 130, which may represent a picture carrier having a nominal frequency of 45.75 MHz. In this case, if CO 121 has a reference frequency fᵣ of 4 MHz and N equals 64, then the minimum change in the output frequency fₒ of LO 120 is Δfₒ=4 MHz/64=62.5 kHz. Accordingly, the ratio of the frequency uncertainty to the minimum frequency step size of LO 120 is 164.7/62.5=2.6. This result indicates that a 2-bit digital number is necessary and sufficient to cover the 164.7 kHz range with a minimum frequency step size. According to an exemplary design, IF SAW filter 130 is a LiNb SAW filter designed to operate at an ambient temperature of 40° C. Therefore, the offset values stored in EEPROM 150 may be as follows:
−1 if ambient temperature=21° C.+/−9.5° C.,
0 if ambient temperature=40° C.+/−9.5° C.,
+1 if ambient temperature=59° C.+/−9.5° C., and
+2 if ambient temperature=78° C.+/−9.5° C.

Next, at step 203, a determination is made as to whether the offset value read from EEPROM 150 at step 202 is valid. According to an exemplary embodiment, processor 170 is programmed to determine that the offset value is valid if it is within the range from −4 to +4, inclusive. Accordingly, offset values outside this range are considered invalid. Of course, different range values may be used at step 203.

If processor 170 determines at step 203 that the offset value is not valid, then process flow advances to step 206 where the algorithm is exited. Alternatively, if processor 170 determines at step 203 that the offset value is valid, then process flow advances to step 204 where processor 170 adds the offset value to the last M value sent to programmable divide-by-M frequency divider 126 at step 201. In this manner, processor 170 generates a new M value for programmable divide-by-M frequency divider 126.

At step 205, processor 170 sends the new M value generated at step 204 to programmable divide-by-M frequency divider 126 of LO 120. This new M value causes LO 120 to adjust its output frequency fₒ and in turn puts the IF frequency applied to the IF SAW filter 130 as close as possible to the appropriate frequency so the signal spectrum coincides with the desired filter characteristics. After step 205, process flow advances to step 206 where the algorithm is exited.

As described herein, the present invention provides a tuning apparatus and method which enables the use of LiNb SAW filters in devices such as television signal receivers, while avoiding problems associated with its temperature dependent characteristics. The present invention is particularly applicable to various apparatuses, either with or without a display device. Accordingly, the phrase “television signal receiver” as used herein may refer to systems or apparatuses capable of receiving television signals, including, but not limited to, television sets, set-top boxes, video cassette recorders (VCRs), digital versatile disk (DVD) players, video game boxes, personal video recorders (PVRs), regardless of whether or not the apparatuses include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A tuning apparatus, comprising:
an RF signal source;
filter means;
tuning means including a local oscillator, said tuning means coupled between said RF signal source and said filter means for providing an IF signal for said filter means, and wherein
said tuning means further includes adjustment means for adjusting an output frequency of said local oscillator in response to a temperature characteristic of said filter means.

2. The tuning apparatus of claim 1, wherein said filter means includes a lithium niobate surface acoustic wave filter.

3. The tuning apparatus of claim 1, wherein said tuning means receives a first control signal from control means which generates said first control signal for controlling said adjustment means.

4. The tuning apparatus of claim 3, wherein said control means includes memory means for storing an offset value corresponding to said temperature characteristic of said filter means.

5. The tuning apparatus of claim 4, wherein said control means generates said first control signal based on said offset value.

6. The tuning apparatus of claim 3, wherein said control means generates said first control signal in response to a second control signal provided by said filter means.

7. A television signal receiver, comprising:
an RF signal source;
a filter;
a tuner including a local oscillator, said tuner coupled between said RF signal source and said filter and being operative to provide an IF signal for said filter, and wherein
said tuner further includes a frequency adjustment mechanism operative to adjust an output frequency of said local oscillator in response to a temperature characteristic of said filter.

8. The television signal receiver of claim 7, wherein said filter includes a lithium niobate surface acoustic wave filter.

9. The television signal receiver of claim 7, further comprising a processor operative to generate a first control signal for controlling said frequency adjustment mechanism.

10. The television signal receiver of claim 9, further comprising a memory operative to store an offset value corresponding to said temperature characteristic of said filter.

11. The television signal receiver of claim 10, wherein said processor generates said first control signal based on said offset value.

12. The television signal receiver of claim 9, wherein said processor generates said first control signal in response to a second control signal provided by said filter.

13. A method for controlling a tuning apparatus, comprising:
receiving an RF signal;
generating an IF signal from said RF signal and providing said IF signal to a filter of said tuning apparatus; and
controlling a frequency of said IF signal based on a temperature characteristic of said filter.

14. The method of claim 13, wherein said filter includes a lithium niobate surface acoustic wave filter.

15. The method of claim 13, further comprised of:
reading an offset value corresponding to said temperature characteristic of said filter; and
using said offset value to control said frequency of said IF signal.

16. The method of claim 13, wherein said frequency of said IF signal is controlled in response to a control signal provided by said filter.
